(19) United States
(12) Patent Application Publication
(10) Pub. No.: US 2011/0063851 A1
(43) Pub. Date: Mar. 17, 2011

(54) EFFICIENT RETROFIT OF LIGHT FIXTURES

(75) Inventor: Sherry Yager, Wayzata, MN (US)

(73) Assignee: SHER LIGHTING LLC, Wayzata, MN (US)

(21) Appl. No.: 12/880,274

(22) Filed: Sep. 13, 2010

Related U.S. Application Data
(60) Provisional application No. 61/241,409, filed on Sep. 11, 2009.

(51) Int. Cl. F21V 7/00; B23P 6/00; F21V 17/00

(52) U.S. Cl. 362/296.01; 29/402.09; 29/428

(57) ABSTRACT

Embodiments of the present invention provide retrofit light fixture assemblies that can be added to existing light fixtures, thereby providing many of the advantages of the newer lighting technology without the time consumption or expense of completely swapping out existing light fixtures while also minimizing the amount of materials to be disposed of. In a first aspect, the invention includes a light fixture assembly having a reflector, a lamp holder, a ballast, and lamp-socket-ballast electrical connectors. The reflector can be adapted to couple to a light fixture housing. The reflector can include an exposed side and a non-exposed side, a downward-reflecting section, and a first lamp-socket aperture in the downward-reflecting section. The lamp holder can be physically attached to the non-exposed side of the reflector. The lamp holder can include a first lamp socket that is configured to receive a first lamp through the first lamp-socket aperture of the reflector. The ballast can include a ballast-power electrical connector adapted to connect to a power source when installed. The lamp-socket-ballast electrical connectors can electrically connect the first lamp socket to the ballast.

### RELATED APPLICATION

This application claims the benefit of U.S. Provisional Patent Application No. 61/241,409, filed Sep. 11, 2009, the contents of which are hereby incorporated by reference.

### TECHNICAL FIELD

Various embodiments relate generally to methods and associated apparatus for retrofitting light fixtures.

### BACKGROUND

Lighting technology has advanced significantly in recent years. The incandescent, metal halide, and high-pressure sodium lamps (to name a few) that have been so common in the past are now being replaced with compact fluorescent, induction, LED, and other newer lamps. Such newer lamps provide several advantages, such as lower energy consumption, longer operational life, improved light output/distribution, energy rebates, tax refunds, and so on.

While the newer lamps are becoming more common in new construction, many existing buildings were constructed with the older kinds of light fixtures. FIG. 1 shows an illustrative embodiment of such an older kind of light fixture 110. The light fixture 110 includes a light fixture housing 112, which is typically mounted to a ceiling, wall, or other fixed structure in a building. The light fixture 110 also includes a lamp holder 116, which is coupled to the light fixture housing 112 via lamp-holder supports 118. The light fixture 110 further includes a ballast 114 for regulating electric power to the lamp socket. The ballast 114 is coupled to the light fixture housing 112 via ballast supports 120. A lamp cover 122 is also coupled to the light fixture housing 112 to conceal the interior components of the light fixture 110. The lamp cover 122 and the visible aspects of the light fixture housing 112 provide the aesthetic appearance of the light fixture 110.

There are several challenges associated with retrofitting existing buildings with newer kinds of light fixtures. Removing the entire existing light fixture 110 can be time consuming, and new light fixtures can be quite expensive. When this time and expense are multiplied over dozens of light fixtures in an existing building, many building owners simply decline to update their light fixtures.

Moreover, a building owner's decision whether to update his/her building's light fixtures can have significant environmental consequences. On one hand, leaving the existing light fixtures in place does not take advantage of the very significant energy savings offered by the newer kinds of light fixtures. On the other hand, removing dozens of light fixtures, like light fixture 110 of FIG. 1, and adding them to landfills can be quite wasteful.

### SUMMARY

Embodiments of the present invention provide retrofit light fixture assemblies that can be added to existing light fixtures, thereby providing many of the advantages of the newer lighting technology without the time consumption or expense of completely swapping out existing light fixtures while also minimizing the amount of materials to be disposed of.

Preferred embodiments include a reflector that, when coupled with the newer kinds of lamps, can provide very significant reductions in energy consumption with similar (or even improved) light output/distribution as compared with the existing light fixture. In particularly preferred embodiments, the reflector is a mirrored reflector, which magnifies the light being produced by the newer kinds of lamps. In even more preferred embodiments, the mirrored reflector can be bent in such a way as to distribute the light in a manner that accords with the needs of the particular space being lit.

### BRIEF DESCRIPTION OF THE DRAWINGS

The following drawings are illustrative of particular embodiments of the present invention and therefore do not limit the scope of the invention. The drawings are not to scale (unless so stated) and are intended for use in connection with the explanations in the following detailed description. Embodiments of the present invention will hereinafter be described in connection with the appended drawings, wherein like numerals denote like elements.

FIG. 1 is a perspective view of a conventional light fixture.

FIG. 2A is a bottom view of a light fixture assembly according to embodiments of the present invention.

FIG. 2B is a top view of the light fixture assembly of FIG. 2A.

FIG. 2C is an end view of the light fixture assembly of FIG. 2A.

FIG. 3 is a bottom view of a light fixture assembly according to embodiments of the present invention.

FIG. 4 is a flow chart illustrating a method of designing and installing a retrofit light fixture assembly in accordance with embodiments of the present invention.

FIG. 5A is a round downlight kit assembly in accordance with some embodiments of the present invention.

FIGS. 5B-5C are round formed assemblies in accordance with some embodiments of the present invention.

FIG. 5D is a rectangular kit assembly in accordance with some embodiments of the present invention.

FIGS. 5E-5F are square (no notch) assemblies in accordance with some embodiments of the present invention.

FIG. 5G is a round (with recessed lamp) assembly in accordance with some embodiments of the present invention.

FIG. 5H is a round (with notches) assembly in accordance with some embodiments of the present invention.

FIGS. 5I-5J are square retrofit (with notched sides) assemblies in accordance with some embodiments of the present invention.

FIG. 5K is a wall sconce incandescent assembly in accordance with some embodiments of the present invention.

FIG. 5L is a shoebox kit assembly in accordance with some embodiments of the present invention.

FIG. 5M is a cylinder fixture kit assembly in accordance with some embodiments of the present invention.

FIG. 5N is an induction shoebox kit assembly in accordance with some embodiments of the present invention.

FIG. 5O is a glass wall sconce kit assembly in accordance with some embodiments of the present invention.

FIG. 5P is a high bay conversion kit assembly in accordance with some embodiments of the present invention.

FIG. 5Q is a Cooper HPTR2325 shoebox retrofit assembly in accordance with some embodiments of the present invention.

FIG. 5R is a canopy kit (4 L) assembly in accordance with some embodiments of the present invention.

FIG. 5S is a shoebox kit assembly in accordance with some embodiments of the present invention.

FIG. 5T is a “Swan” fixture retrofit kit assembly in accordance with some embodiments of the present invention.

### DETAILED DESCRIPTION

The following detailed description is exemplary in nature and is not intended to limit the scope, applicability, or configuration of the invention in any way. Rather, the following description provides practical illustrations for implementing exemplary embodiments of the present invention. Examples of constructions, materials, dimensions, and manufacturing processes are provided for selected elements, and all other elements employ that which is known to those of skill in the field of the invention. Those skilled in the art will recognize that many of the examples provided have suitable alternatives that can be utilized.

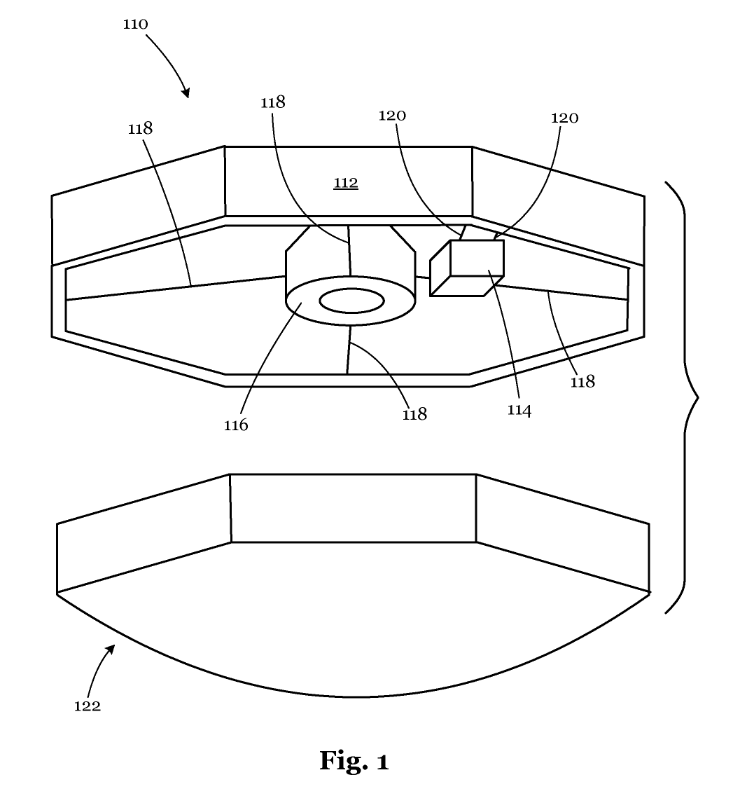

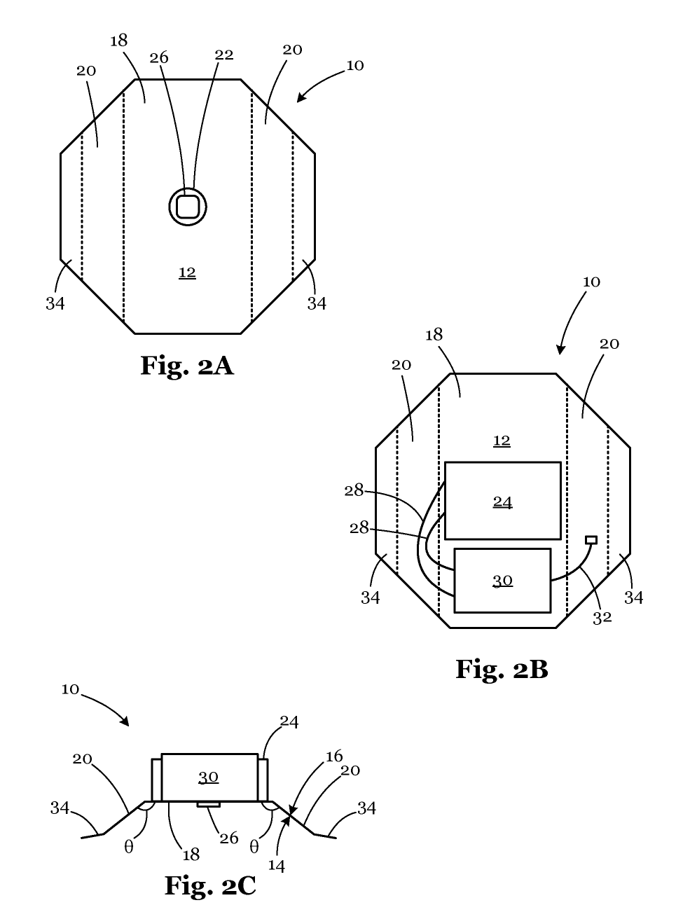

FIGS. 2A-2C show a light fixture assembly 10 according to some embodiments of the present invention. In many embodiments, the light fixture assembly 10 is a ready-to-install retrofit light fixture assembly. As discussed elsewhere herein, retrofit light fixture assemblies can be used to retrofit existing light fixtures with newer-technology lamps. However, it is to be understood that the concepts and features discussed herein in connection with retrofit light fixture assemblies can also be incorporated into new light fixtures to provide many of the same advantages. The light fixture assembly 10 of FIGS. 2A-2C lacks a housing (e.g., 112 in FIG. 1) and a lamp cover (e.g., 122 in FIG. 1) because the light fixture assembly 10 can be incorporated into an existing light fixture, making use of the existing housing and lamp cover.

The light fixture assembly 10 can include a reflector 12 for magnifying the light produced by the lamp and distributing it according to the needs of the space. The reflector 12 can serve as the primary support structure of the light fixture assembly 10 and can be adapted to couple to a light fixture housing (e.g., 112 in FIG. 1) to create a retrofit light fixture. In many embodiments, ridge sections 34 (discussed in greater detail below) and/or other structural features of the reflector 12 can be adapted to aid in coupling the reflector 12 to the light fixture housing. Other fasteners and/or hardware can be incorporated into the reflector 12 and/or the light fixture housing to couple the reflector 12 to the housing. The reflector 12 can include a lamp-socket aperture 22 in the downward-reflecting section 18. The function of the lamp-socket aperture 22 is discussed in greater detail below.

As shown, the reflector 12 has an exposed side 14, and a non-exposed side 16. The exposed side 14 is generally illuminated when a lamp is installed and activated. The non-exposed side 16 is generally where other components of the light fixture assembly 10 are positioned, thereby preventing those components from creating shadows.

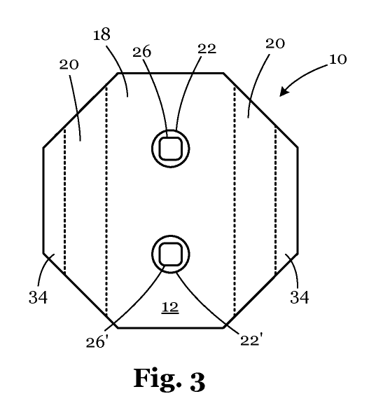

The shape of the reflector 12 can be adjusted to control the distribution of light. As shown, the reflector 12 has multiple sections, including a downward-reflecting section 18, two downward-and-outward-reflecting sections 20, and two ridge sections 34. The downward-reflecting section 18 generally functions to reflect light in a downward vertical direction when the light fixture is oriented horizontally. The downward-and-outward-reflecting sections 20 can be positioned proximate to opposing edges of the downward-reflecting section 18. The downward-and-outward-reflecting sections 20 add a horizontal component to the direction in which they reflect light when the light fixture is oriented horizontally. (Of course, if the light fixture is oriented other than horizontally (e.g., vertically on a wall rather than horizontally on a ceiling), the direction in which the downward-reflecting section 18 and the downward-and-outward-reflecting sections 20 reflect light is changed accordingly.) In many embodiments, the downward-and-outward-reflecting sections 20 can form obtuse angles with the downward-reflecting section 18, with angle θ being between 90° and 180°. In some configurations, the downward-and-outward-reflecting sections 20 can be arranged symmetrically about the lamp-socket aperture 22. Similarly, in embodiments with multiple lamp-socket apertures (e.g., FIG. 3), the downward-and-outward-reflecting sections 20 can be arranged symmetrically about the lamp-socket apertures. As shown, the ridge sections 34 are positioned proximate to the downward-and-outward-reflecting sections 20, thereby enabling the ridge sections 34 to contribute in coupling the light fixture assembly 10 to the light fixture housing.

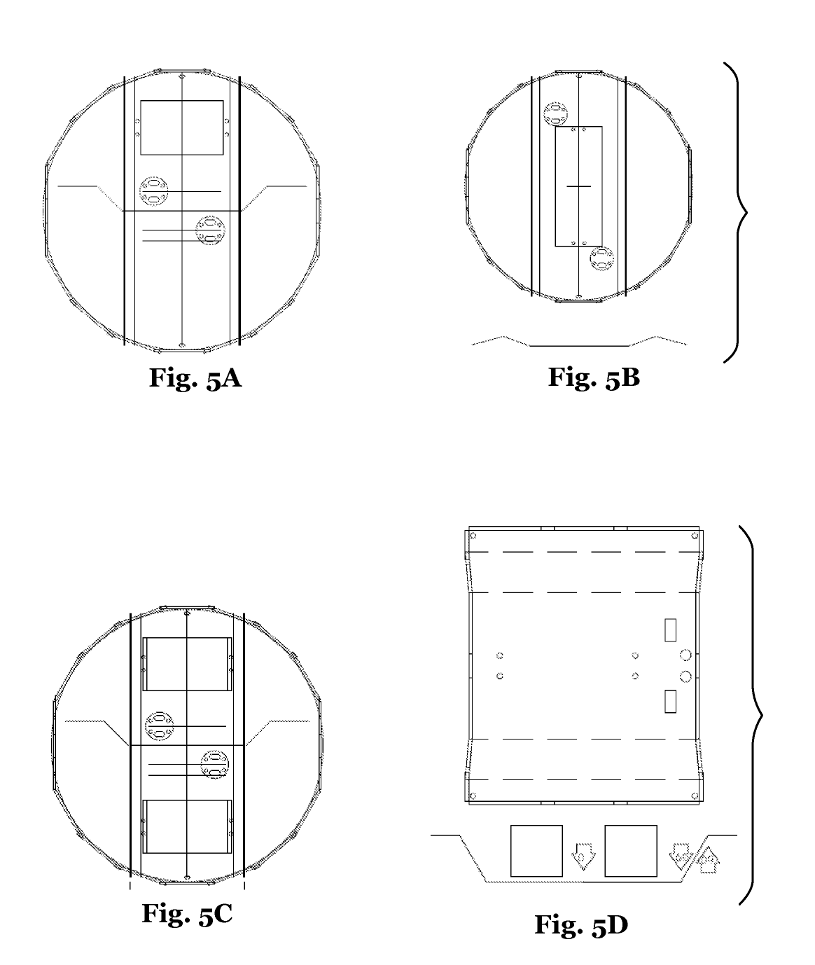

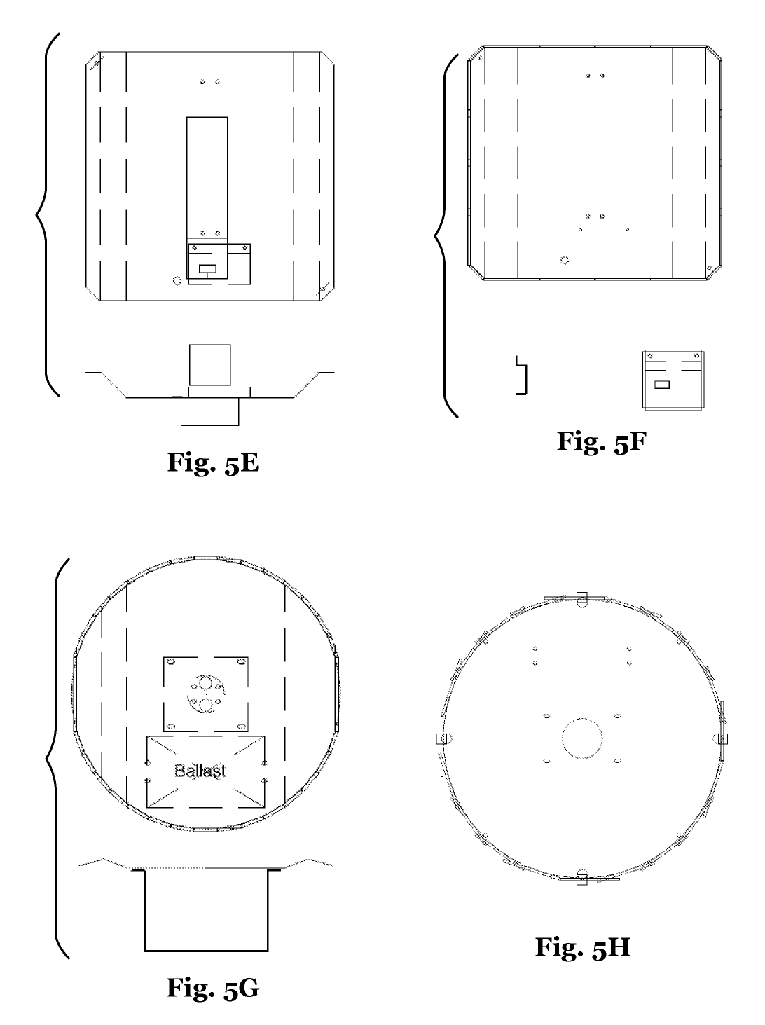

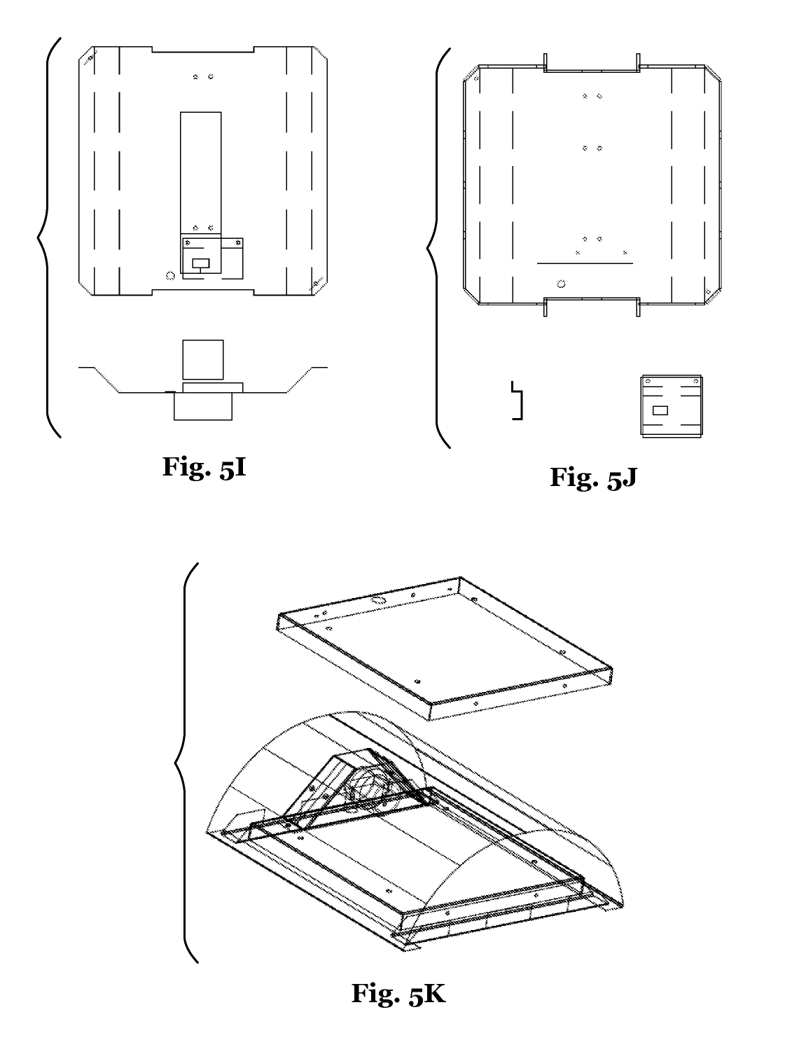

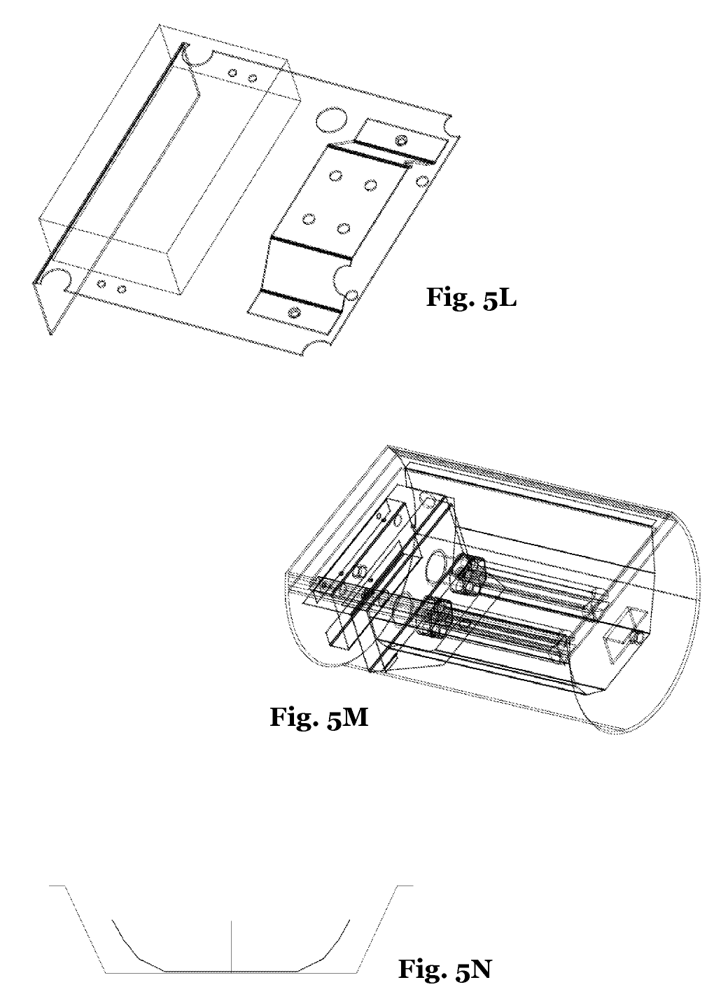

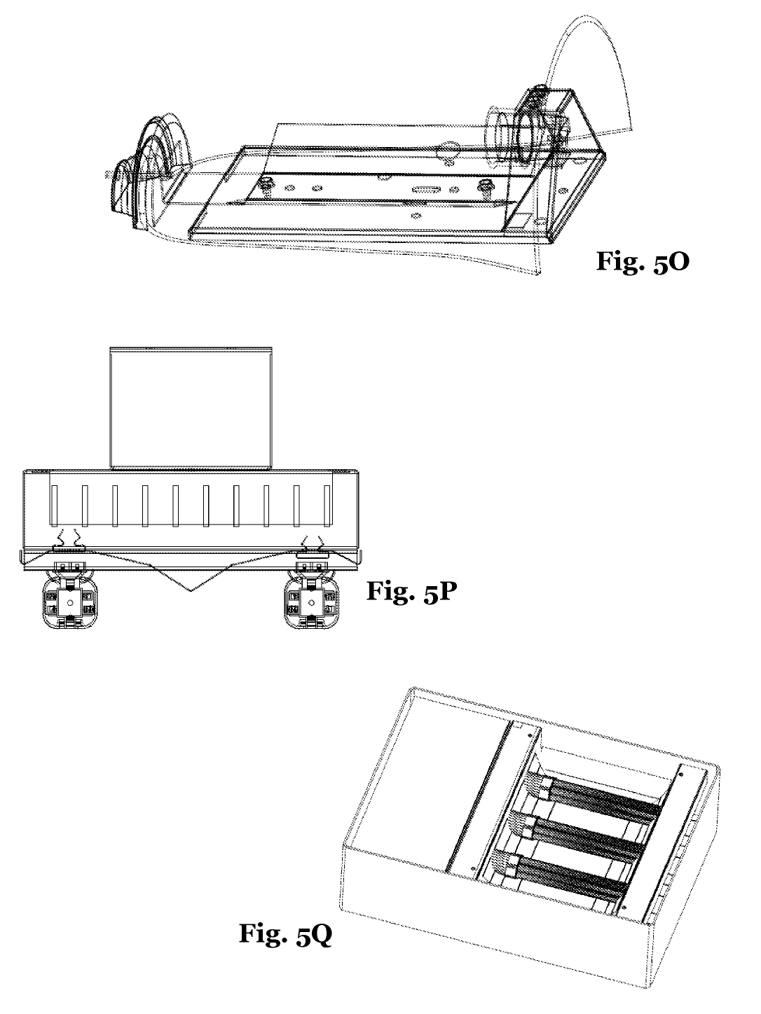

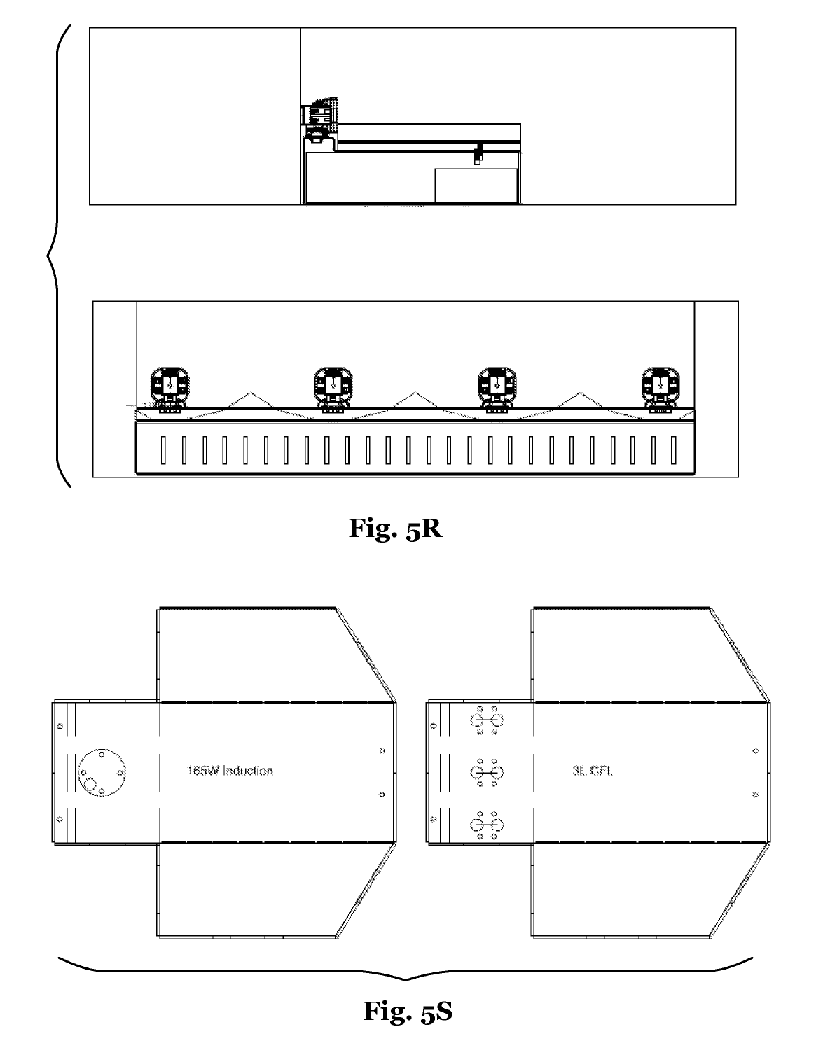

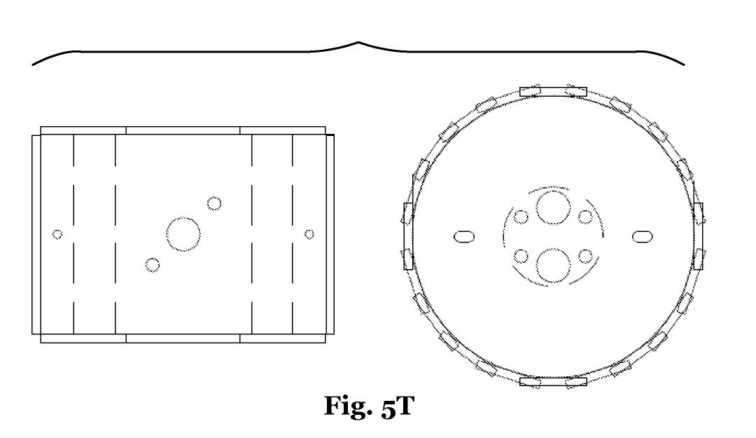

Though the reflector 12 of FIGS. 2A-2C include one downward-reflecting section 18, two downward-and-outward-reflecting sections 20, and two ridge sections 34, many alternative configurations are possible, depending on the type of light fixture, the desired light output/distribution, and a variety of other factors. Various reflector configurations are shown in FIGS. 5A-5T.

In particularly preferred embodiments, the reflector 12 can be a mirrored reflector. The mirrored finish on the exposed side 14 of the reflector 12 can greatly enhance the reflecting capabilities of the reflector 12. The mirrored finish can be highly reflective and/or polished. In some embodiments, the thickness of the reflector 12 can be approximately 0.032 inches. Reflector materials can be chosen based on their ability to withstand (e.g., not peel or flake) exposure to varied temperatures. In some embodiments, the mirrored reflector can provide approximately 95% reflection. In some embodiments a white reflector can be used. In some such embodiments, the white reflector can provide approximately 92% reflection.

The light fixture assembly 10 can include a lamp holder 24 that is physically attached to the non-exposed side 16 of the reflector. Physical attachment of the lamp holder 24 to the reflector 12 can be an important aspect of making the light fixture assembly 10 a ready-to-install light fixture assembly. As shown in FIG. 1, the lamp holder 116 of a light fixture 110 is typically attached directly to the housing 112. This is true even for light fixtures that have some form of reflector. Referring to FIG. 1 and FIGS. 2A-2C, if the retrofit lamp holder 24 is not physically attached to the reflector 12, the operator charged with retrofitting the target light fixture 110 must first go up and remove the existing lamp holder 116 and corresponding supports 118 and then install the retrofit lamp holder 24 and reflector 12 in two separate steps. The extra step can take a considerable amount of time, and when that time is multiplied over dozens of light fixtures, the difference can be quite significant. In contrast, if the lamp holder 24 is already physically attached to the reflector 12, and all the operator needs to do after removing the existing lamp holder 116 and corresponding supports 118 is couple the reflector 12 to the housing 112, considerable time savings can be realized.

The lamp holder 24 can include a lamp socket 26 that is configured to receive a lamp. Examples of lamps that can be used in connection with embodiments of the present invention include CFL, induction, LED, HID, and so on. The lamp socket 26 can be configured to receive the lamp through the lamp-socket aperture 22 of the reflector 12. In some embodiments, the entrance of the lamp socket 26 extends past the lamp-socket aperture 22; in some embodiments, the entrance of the lamp socket 26 is flush with the reflector; and in some embodiments, the lamp socket 26 is on the non-exposed side 16 of the reflector 12.

FIG. 3 shows a light fixture assembly 10 configured to accommodate two lamps. The reflector 12 includes a lamp-socket aperture 22′ in the downward-reflecting section 18. The lamp holder 24 includes a lamp socket 26′ configured to receive a second lamp through lamp-socket aperture 22′ of the reflector 12. The quantity and arrangement of lamp sockets and lamp-socket apertures can vary depending on the type of light fixture, the desired light output/distribution, and a variety of other factors. Various configurations are shown in FIGS. 5A-5T.

Referring again to FIGS. 2A-2C, the light fixture assembly 10 can include a ballast for regulating electrical power to the lamp socket 26. In some embodiments, the ballast 30 can be a retrofit ballast. The ballast 30 can include a ballast-power electrical connector 32 that is adapted to connect to a power source within the light fixture housing (e.g., 112 in FIG. 1). In preferred embodiments, the ballast 30 can be programmable (e.g., for parking garages or outdoor lighting). In particularly preferred embodiments, the ballast 30 can be configured to accommodate motion-sensor lamps.

In various embodiments of the present invention, the ballast 30 can be positioned in a few different ways relative to the reflector 12. In some embodiments, the ballast can be physically attached to the non-exposed side 16 of the reflector 12. In some such embodiments, the ballast 30 can be arranged on the non-exposed side 16 of the reflector 12 so as not to interfere with an existing ballast (e.g., 114 in FIG. 1) within the light fixture housing (e.g., 112 in FIG. 1) when installed. In embodiments in which space within the existing housing is more limited, the ballast 30 can be connected via electrical connectors to the lamp holder 24 of the light fixture assembly 10 (discussed in greater detail below) but not physically attached to the reflector 12. In such embodiments, the ballast 30 can be positioned within the existing housing (or elsewhere—e.g., within a lamp pole) wherever space permits.

As alluded to above, the light fixture assembly 10 can include lamp-socket-ballast electrical connectors 28 that electrically connect the lamp socket 26 and the ballast 30. Like the physical attachment of the lamp holder 24 to the reflector 12 discussed above, the lamp-socket-ballast electrical connectors 28 can play an important role in making the light fixture assembly 10 a ready-to-install retrofit light fixture assembly. The physical attachment between the reflector 12 and the lamp holder 24 and between the lamp holder 24 and the ballast 30 (and often between the ballast 30 and the reflector 12), an operator can easily carry the whole light fixture assembly 10 to the target light fixture in one trip to perform the retrofit.

The light fixture assembly 10 can be used in methods of quickly and efficiently retrofitting a target light fixture (e.g., 110 in FIG. 1) while minimizing materials to be disposed of. A ready-to-install retrofit light fixture assembly 10 can be provided. The ballast-power electrical connector 32 can be connected to a power source within an existing light fixture housing (e.g., 112 in FIG. 1) of the target light fixture. The reflector 12 can be coupled to the existing light fixture housing, thereby eliminating any need to remove and dispose of the existing light fixture housing. In some preferred embodiments, the reflector 12 can be positioned such that the retrofit ballast 30 does not interfere with an existing ballast (e.g., 114 in FIG. 1) within the existing light fixture housing before coupling the reflector 12 to the existing light fixture housing, thereby eliminating any need to dispose of the existing ballast. In many embodiments, coupling the reflector 12 to the existing light fixture housing includes mating the ridge sections 34 with corresponding features of the existing light fixture housing.

Retrofit methods discussed herein can target several different kinds of existing light fixtures. Examples of target light fixture assemblies include low bay fixtures, high bay fixtures, shoebox fixtures, wall pack fixtures, street light fixtures, wall sconce fixtures, canopy fixtures, recessed fixtures, recessed ceiling fixtures, exterior bollard fixtures, exterior swan/gooseneck fixtures, and so on.

Retrofit methods discussed herein can provide various advantages. For example, many retrofit light fixtures produced via retrofit light fixture assemblies discussed herein can require less than 50% of the wattage of the corresponding target light fixtures. Some preferred retrofit light fixtures produced via retrofit light fixture assemblies discussed herein can require less than 35% of the wattage of the corresponding target light fixtures. Some particularly preferred retrofit light fixtures produced via retrofit light fixture assemblies discussed herein can require less than 25% of the wattage of the corresponding target light fixtures. The following table illustrates conversions that have been achieved by embodiments of the present invention:

| Target Light Fixture | Retrofit Light Fixture |
|---|---|
| 400-Watt Metal Halide or | 165-Watt CFL |
| High-Pressure Sodium | |
| 250-Watt Metal Halide or | 84-Watt CFL |
| High-Pressure Sodium | |
| 175-Watt Metal Halide or | 57-Watt CFL |
| High-Pressure Sodium | |
| 150-Watt Metal Halide or | 57-Watt CFL |
| High-Pressure Sodium | |
| 100-Watt Metal Halide or | 42-Watt CFL |
| High-Pressure Sodium | |
| 70-Watt Metal Halide or | 26-Watt CFL |
| High-Pressure Sodium | |

A ratio of light output to electrical power consumption can be likewise improved. Embodiments of the present invention can also significantly reduce a building's carbon footprint. Additionally, given the reduction in energy input achieved by many embodiments of the present invention, the resulting retrofit light fixture can also operate at a substantially reduced temperature, thereby improving the longevity of the retrofit light fixture. Many embodiments of the present invention work well in outdoor environments, even in cold weather climates.

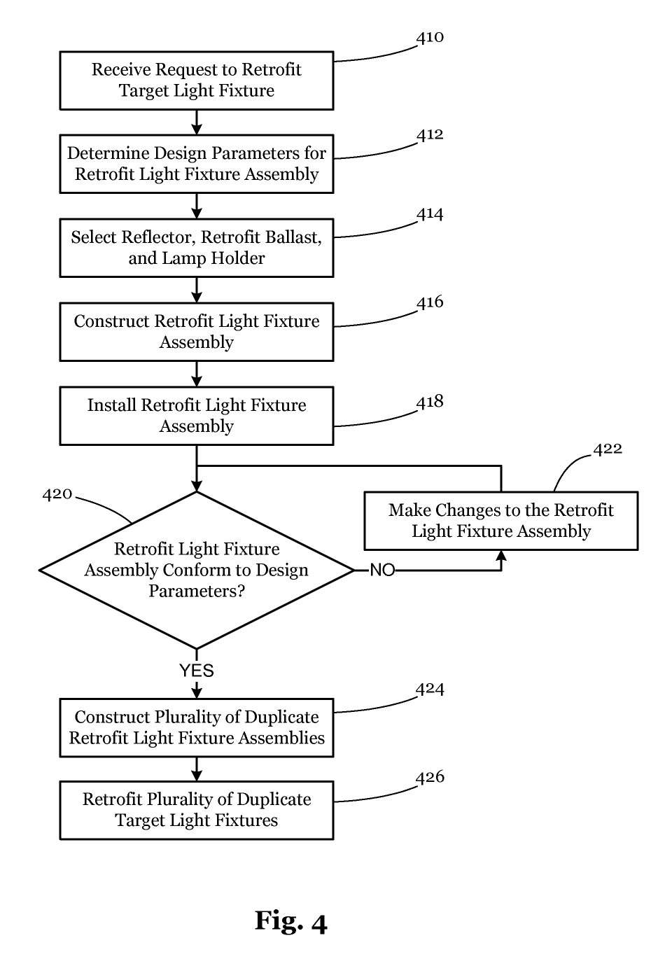

FIG. 4 illustrates a method of designing and installing a retrofit light fixture assembly in accordance with embodiments of the present invention. The method typically commences with a retrofitter (e.g., an electrician) receiving a request to retrofit a target light fixture (410). The request can come from any building owner who wants to retrofit one or more light fixtures in his/her building.

Having received the request to retrofit a target light fixture, the retrofitter can determine design parameters for the retrofit light fixture assembly (412). Examples of design parameters can include a desired light output level, a light distribution pattern, and a configuration of an existing light fixture housing of the target light fixture. In particularly preferred embodiments, design parameters can further include the cost of installing/maintaining the newer lamps, the ease of maintenance of the eventual retrofit light fixture, and other similar factors. Applicable building codes also often factor into the design of the retrofit light fixture assembly.

With the design parameters in hand, the retrofitter can select a reflector, a retrofit ballast, and a lamp holder based on those design parameters (414). The reflector, retrofit ballast, and lamp holder can have attributes such as those discussed elsewhere herein.

The retrofitter can then construct the retrofit light fixture assembly (416). The lamp holder can be physically attached to the non-exposed side of the reflector. One or more lamp sockets of the lamp holder can each be configured to receive a lamp through a lamp-socket aperture of the reflector. The lamp socket(s) can be electrically connected to the retrofit ballast via lamp-socket-ballast electrical connectors.

In constructing the retrofit light fixture assembly, the arrangement of the retrofit ballast can depend on a variety of factors, such as the type of target light fixture. In some embodiments (e.g., garage fixtures, low bay fixtures, wall sconces, swan fixtures, bollard fixtures, street fixtures, shoebox fixtures, wall pack fixtures, canopy fixtures, etc.), constructing the retrofit light fixture assembly can include physically attaching the retrofit ballast to the non-exposed side of the reflector. In some embodiments (e.g., high bay fixtures, canopy fixtures, shoebox fixtures, bollard fixtures, street fixtures, wall pack fixtures, etc.), the retrofit ballast can be electrically connected to the lamp socket(s) but not physically attached to the reflector. Such considerations are also discussed elsewhere herein.

With the retrofit light fixture fully constructed, the retrofitter can install the retrofit light fixture assembly (418). In preferred embodiments, this can be done by disconnecting but not removing an existing ballast of the target light fixture. Installation can include electrically connecting the retrofit ballast to a power source within the existing light fixture housing via a ballast-power electrical connector. Installation can further include coupling the reflector to the existing light fixture housing, thereby eliminating any need to remove and dispose of the existing light fixture housing. In embodiments in which the retrofit ballast is electrically connected to the lamp socket(s) but not physically attached to the reflector, installation can involve coupling the retrofit ballast to the existing light fixture housing. In preferred embodiments, only the existing lamp holder (e.g., 116 in FIG. 1) and the corresponding supports (e.g., 118 in FIG. 1) need to be removed and disposed of. All of the other components can either be reused or remain within the existing housing in an inoperable state.

The retrofitter can then determine how the retrofit light fixture assembly performs in comparison to the design parameters (420). The retrofitter can use standard measurement techniques. If the retrofit light fixture assembly does not conform to the design parameters, the retrofitter can make changes to the retrofit light fixture assembly in order to bring performance of the retrofit light fixture assembly into conformance with the design parameters (422). Such changes can include changing the bend configuration of the reflector, adding or subtracting lamp sockets, changing the configuration of the lamp socket(s), and so on. Retrofit light fixture assemblies that conform to the design parameters can provide several advantages, such as those discussed elsewhere herein.

When the retrofit light fixture assembly conforms to the design parameters, the retrofitter can construct a plurality of duplicate retrofit light fixture assemblies (424). The retrofitter can then retrofit a plurality of duplicate target light fixture assemblies with the duplicate retrofit light fixture assemblies. In some embodiments, retrofitting the duplicate target light fixture assemblies with the duplicate retrofit light fixture assemblies can be done at a rate of one retrofit per 20 minutes. In preferred embodiments, retrofitting the duplicate target light fixture assemblies with the duplicate retrofit light fixture assemblies can be done at a rate of one retrofit per 15 minutes. In particularly preferred embodiments, retrofitting the duplicate target light fixture assemblies with the duplicate retrofit light fixture assemblies can be done at a rate of one retrofit per 10 minutes. Such time measurements are taken from when the retrofitter removes the lamp cover to when he/she restores the lamp cover.

In the foregoing detailed description, the invention has been described with reference to specific embodiments. However, it may be appreciated that various modifications and changes can be made without departing from the scope of the invention as set forth in the appended claims. Thus, some of the features of preferred embodiments described herein are not necessarily included in preferred embodiments of the invention which are intended for alternative uses.

What is claimed is:

1. A ready-to-install retrofit light fixture assembly, comprising:
(a) a reflector adapted to couple to a light fixture housing, the reflector including (i) an exposed side and a non-exposed side, (ii) a downward-reflecting section, and (iii) a first lamp-socket aperture in the downward-reflecting section;
(b) a lamp holder physically attached to the non-exposed side of the reflector and including a first lamp socket configured to receive a first lamp through the first lamp-socket aperture of the reflector;
(c) a retrofit ballast including a ballast-power electrical connector adapted to connect to a power source within the light fixture housing; and
(d) lamp-socket-ballast electrical connectors that electrically connect the first lamp socket and the retrofit ballast.

2. The assembly of claim 1, wherein the retrofit ballast is physically attached to the non-exposed side of the reflector.

3. The assembly of claim 2, wherein the retrofit ballast is arranged on the non-exposed side of the reflector so as not to interfere with an existing ballast within the light fixture housing.

4. The assembly of claim 1, wherein the reflector further includes (iv) at least two downward-and-outward-reflecting sections proximate to opposing edges of the downward-reflecting section, the at least two downward-and-outward-reflecting sections forming obtuse angles with the downward-reflecting section.

5. The assembly of claim 4, wherein the reflector further includes (v) at least two ridge sections proximate to the at least two downward-and-outward-reflecting sections, the at least two ridge sections being adapted to aid in coupling of the reflector to the light fixture housing.

6. The assembly of claim 4, wherein the at least two downward-and-outward-reflecting sections are arranged symmetrically about the first lamp-socket aperture.

7. The assembly of claim 1, wherein the reflector comprises a mirrored reflector.

8. The assembly of claim 1, wherein the reflector includes a second lamp-socket aperture in the downward-reflecting section and the lamp holder includes a second lamp socket configured to receive a second lamp through the second lamp-socket aperture of the reflector.

9. A method of quickly and efficiently retrofitting a target light fixture while minimizing materials to be disposed of, the method comprising the steps of:
(a) providing a ready-to-install retrofit light fixture assembly that includes:
(i) a reflector including (A) an exposed side and a non-exposed side, (B) a downward-reflecting section, and (C) a first lamp-socket aperture in the downward-reflecting section,
(ii) a lamp holder physically attached to the non-exposed side of the reflector and including a first lamp socket configured to receive a first lamp through the first lamp-socket aperture of the reflector,
(iii) a retrofit ballast including a ballast-power electrical connector, and
(iv) lamp-socket-ballast electrical connectors that electrically connect the first lamp socket and the retrofit ballast;
(b) connecting the ballast-power electrical connector to a power source within an existing light fixture housing of the target light fixture; and
(c) coupling the reflector to the existing light fixture housing to create a retrofit light fixture, thereby eliminating any need to remove and dispose of the existing light fixture housing.

10. The method of claim 9, wherein the retrofit ballast of the retrofit light fixture assembly is physically attached to the non-exposed side of the reflector.

11. The method of claim 10, further comprising positioning the reflector of the retrofit light fixture assembly such that the retrofit ballast does not interfere with an existing ballast within the existing light fixture housing before coupling the reflector to the existing light fixture housing, thereby eliminating any need to dispose of the existing ballast.

12. The method of claim 9, wherein the reflector of the retrofit light fixture assembly further includes (D) at least two downward-and-outward-reflecting sections proximate to opposing edges of the downward-reflecting section, the at least two downward-and-outward-reflecting sections forming obtuse angles with the downward-reflecting section.

13. The method of claim 12, wherein the reflector of the retrofit light fixture assembly further includes (E) at least two ridge sections proximate to the at least two downward-and-outward-reflecting sections, and wherein coupling the reflector to the existing light fixture housing includes mating the at least two ridge sections with corresponding features of the existing light fixture housing.

14. The method of claim 9, wherein the reflector of the retrofit light fixture assembly includes a second lamp-socket aperture in the downward-reflecting section and the lamp holder includes a second lamp socket configured to receive a second lamp through the second lamp-socket aperture of the reflector.

15. The method of claim 9, wherein the reflector of the retrofit light fixture assembly comprises a mirrored reflector.

16. The method of claim 9, wherein the target light fixture is selected from a group consisting of a low bay fixture, a high bay fixture, a shoebox fixture, a wall pack fixture, a street light fixture, a wall sconce fixture, a canopy fixture, and a recessed fixture.

17. The method of claim 9, wherein the retrofit light fixture requires less than 50% of the wattage of the target light fixture.

18. A method of designing and installing a retrofit light fixture assembly to create a retrofit light fixture, the method comprising the steps of:
(a) receiving a request to retrofit a target light fixture;
(b) determining design parameters for the retrofit light fixture assembly, the design parameters including a desired light output level, a light distribution pattern, and a configuration of an existing light fixture housing of the target light fixture;
(c) selecting a reflector, a retrofit ballast, and a lamp holder based on the design parameters;
(d) constructing the retrofit light fixture assembly by (i) physically attaching the lamp holder to a non-exposed side of the reflector such that one or more lamp sockets of the lamp holder are each configured to receive a lamp through a lamp-socket aperture of the reflector and (ii) electrically connecting the one or more lamp sockets to the retrofit ballast via lamp-socket-ballast electrical connectors;
(e) installing the retrofit light fixture assembly without removing an existing ballast of the target light fixture by (i) electrically connecting the retrofit ballast to a power source within the existing light fixture housing of the target light fixture via a ballast-power electrical connector and (ii) coupling the reflector to the existing light fixture housing, thereby eliminating any need to remove and dispose of the existing light fixture housing;
(f) determining how the retrofit light fixture assembly performs in comparison to the design parameters; and
(g) making any changes to the retrofit light fixture assembly in order to bring performance of the retrofit light fixture assembly into conformance with the design parameters, thereby creating the retrofit light fixture.

19. The method of claim 18, wherein the retrofit light fixture requires less than 50% of the wattage that the target light fixture required.

20. The method of claim 18, wherein the reflector is divided into the downward-reflecting section and at least two downward-and-outward-reflecting sections, the at least two downward-and-outward-reflecting sections forming obtuse angles with the downward-reflecting section.

21. The method of claim 18, wherein constructing the retrofit light fixture assembly further includes (iii) physically attaching the retrofit ballast to the non-exposed side of the reflector.

22. The method of claim 18, wherein installing the retrofit light fixture assembly further includes (iii) coupling the retrofit ballast to the existing light fixture housing.

23. The method of claim 18, further comprising (h) constructing a plurality of duplicate retrofit light fixture assemblies after making any changes to the retrofit light fixture assembly and (i) retrofitting a plurality of duplicate target light fixtures with the duplicate retrofit light fixture assemblies at a rate of one retrofit per 25 minutes.

24. A light fixture assembly, comprising:
(a) a reflector adapted to couple to a light fixture housing, the reflector including (i) an exposed side and a non-exposed side, (ii) a downward-reflecting section, and (iii) a first lamp-socket aperture in the downward-reflecting section;
(b) a lamp holder physically attached to the non-exposed side of the reflector and including a first lamp socket configured to receive a first lamp through the first lamp-socket aperture of the reflector;
(c) a ballast including a ballast-power electrical connector adapted to connect to a power source when installed;
(d) lamp-socket-ballast electrical connectors that electrically connect the first lamp socket to the ballast.

25. The assembly of claim 25, wherein the reflector further includes (iv) at least two downward-and-outward-reflecting sections proximate to opposing edges of the downward-reflecting section, the at least two downward-and-outward-reflecting sections forming obtuse angles with the downward-reflecting section.

26. The assembly of claim 26, wherein the reflector further includes (v) at least two ridge sections proximate to the at least two downward-and-outward-reflecting sections, the at least two ridge sections being adapted to aid in coupling of the reflector to the light fixture housing.

27. The assembly of claim 25, wherein the reflector comprises a mirrored reflector.
